(19) United States
(12) Patent Application Publication
(10) Pub. No.: US 2026/0119970 A1
(43) Pub. Date: Apr. 30, 2026

(54) System and Method of Developing Sparse Language Model

(71) Applicant: KIMBERLY ROXANNE JOHNSON, New Orleans, LA (US)

(72) Inventor: KIMBERLY ROXANNE JOHNSON, New Orleans, LA (US)

(21) Appl. No.: 18/927,549

(22) Filed: Oct. 25, 2024

(51) Int. Cl. G06N 20/00; H04L 9/40

(52) U.S. Cl. CPC G06N 20/00; H04L 63/08

(57) ABSTRACT

This invention describes methods and systems for utilizing blockchain-verified sparse language models (SLMs) in enterprise applications. Sparse models address the limitations of large language models (LLMs) by reducing overfitting, bias, and complexity, while blockchain integration ensures result verification and maintains immutable records of model operations. The system employs smart contracts for automated validation and distributed consensus mechanisms to verify model outputs. This comprehensive approach leads to improved transparency, trust, and cost-efficiency through both model sparsification and blockchain-based accountability, making these verified SLMs particularly suitable for high-risk applications. The invention's combination of sparse modeling techniques with blockchain verification creates a robust framework for deploying trustworthy and efficient language models in critical enterprise environments.

### BACKGROUND

### Field of the Invention

The present invention relates to the field of Artificial Intelligence (AI), specifically addressing the growing but nascent topic of Sparse Language Models. Within this domain, the invention particularly focuses on applications in Collaborative Filtering and Feature Engineering. Furthermore, this invention introduces an innovative approach by integrating blockchain technology to enhance the reliability and verification of sparse Language Model (LLM) inference results. This integration is crucial for critical applications where the accuracy and trustworthiness of AI-generated outputs are paramount.

The invention leverages the decentralized and immutable nature of blockchain to create a novel framework for verifying the correctness of sparse LLM inference results. This approach not only advances the state of the art in AI model validation but also opens new avenues for ensuring the integrity of AI systems in high-stakes environments. By combining sparse language models with blockchain technology, this invention aims to address key challenges in AI reliability, transparency, and accountability, particularly in scenarios where the consequences of incorrect inferences could be significant.

### Description of the Related Art

Sparse or small language models utilize sparse data models to eliminate data overfitting and bias while decreasing cost and complexity of a system for deployment.
Although the field of large language models (LLMs) has seen significant growth in recent years, driven by advances in deep learning and the availability of massive datasets of text and code, LLMs have not been successful in enterprise high-risk applications due to lack of trust and transparency, data quality and bias, liability and risk, cost and complexity, and lack of standards and regulations.
Blockchain technology can be used to verify the correctness of sparse LLM inference results to improve data quality, which is especially important for critical applications.
LLMs adoption in the enterprise is challenging for several reasons, including data sparsity and cold start problem, scalability, overfitting and data bias, privacy concerns, and explainability and transparency. The systems and methods of a sparse language model described will negate these challenges.

### SUMMARY

The present invention introduces a novel approach to Sparse Language Models, integrating blockchain technology to enhance their functionality, reliability, and ability to deploy. This innovative combination addresses key challenges in the field of Artificial Intelligence, particularly in the areas of Collaborative Filtering and Feature Engineering.

In one embodiment of the present invention, the complexity of language models is significantly simplified, and the data required for these models (represented by sparse n-grams) is maximally decreased for deployment. This reduction in complexity and data requirements is achieved through advanced sparse modeling techniques, optimizing the model's performance while minimizing its computational and storage footprint. Key features of the invention include versatile deployment options (on-premise, on-machine, or in the cloud), blockchain integration, decentralized verification, enhanced security, scalability, and collaborative potential.

This invention represents a significant advancement in the field of AI, offering a robust solution that combines the efficiency of Sparse Language Models with the security and transparency of blockchain technology. It has the potential to revolutionize how language models are deployed and utilized across various industries, particularly in applications where reliability and verifiability are critical.

### BRIEF DESCRIPTION OF THE DRAWINGS

In the following detailed portion of the present description, the particulars of the present application will be explained in more detail with reference to the example embodiment shown in the drawings, in which:

FIG. 1 is a pictorial representation of the overall Sparse Translation System Supporting Blockchain Integration for this embodiment,

FIG. 2 is a pictorial representation of the Sparse Language Model contained in this embodiment,

FIG. 3 is a pictorial representation of a Machine Learning Model contained in this embodiment,

FIG. 4 is a pictorial representation of the Simplified Blockchain Structure contained in this embodiment, and

FIG. 5 is a pictorial representation of the Smart Contract Rules and Automation Process contained in this embodiment.

### DETAILED DESCRIPTION

In the following detailed description, this invention proposes an approach to achieve sparsity in a language model utilizing and integrating blockchain technology.

The present invention is illustrated through five detailed figures, each representing crucial aspects of the sparse language model system with blockchain integration. These figures collectively demonstrate the innovative combination of sparse language processing technologies with blockchain verification mechanisms.

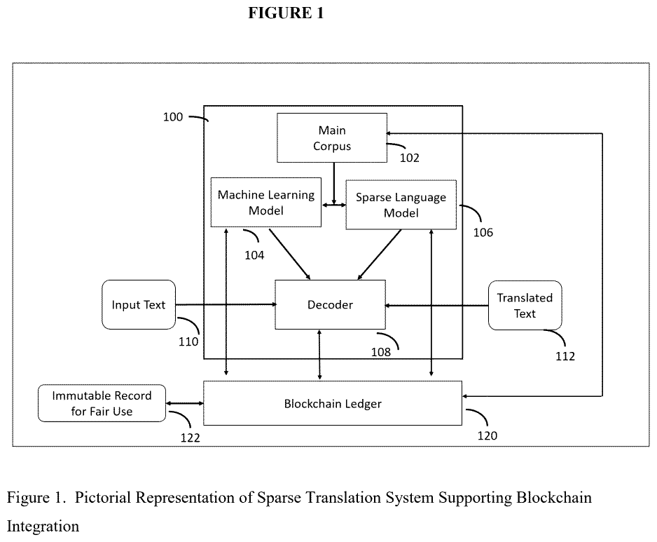

In FIG. 1, the invention incorporates blockchain technology into the Sparse Translation System 100 to verify and ensure the correctness of sparse LLM inference results. The system includes a main corpus 102, a machine language model 104, a sparse language model 106, and a decoder 108. Providing input text 110 to the sparse translation system 100 produces translated text 112. The decoded text is fed into the Blockchain Ledger 120 which then creates an Immutable Record for Fair Use 122. The system architecture demonstrates how blockchain technology is leveraged to create an immutable record of model usage and ensure fair, verifiable utilization of the sparse language model.

The Main Corpus 102 provides the training data for the initial Machine Learning Model 104. This interaction involves data preprocessing, feature extraction, and model training. After training, the dense Machine Learning Model 104 is converted into a Sparse Language Model 106. After training, the dense Machine Learning Model 104 is converted into a Sparse Language Model 106. This process involves pruning, quantization, or structured sparsity techniques. The sparse model may be further refined using the Main Corpus, which will involve fine-tuning or additional sparsification based on corpus statistics. This integration is particularly crucial for critical applications where the accuracy and trustworthiness of AI-generated outputs are paramount.

The system's Blockchain Ledger 120 serves as the foundational component, maintaining an immutable record of all system interactions, including model access events, translation requests, resource utilization metrics, and user authentication records. This ledger interfaces with the Fair Use Verification Module 122 to enforce usage policies and maintain accountability through detailed transaction tracking and compliance monitoring.

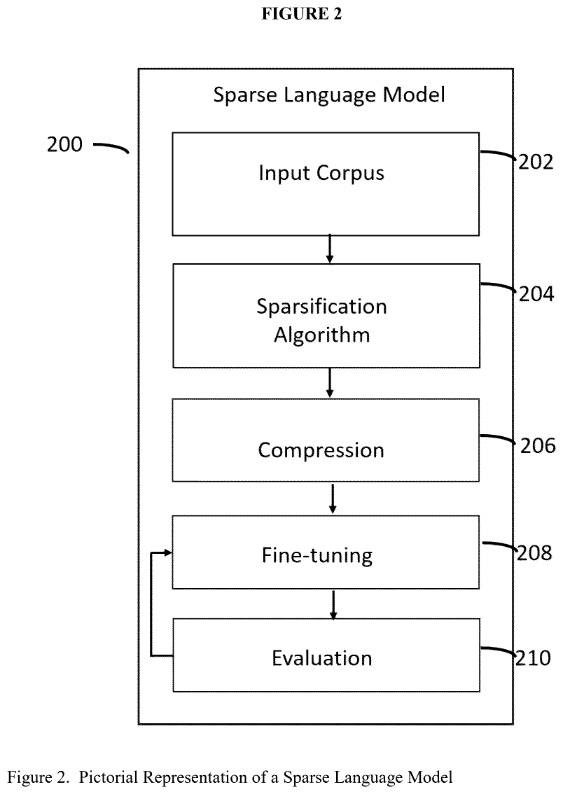

In FIG. 2, the detailed architecture of the Sparse Language Model 200 represents the core processing unit, depicting the transformation of data from initial input through multiple processing stages to achieve an optimized, compressed model. The process flow involves several key stages connected in a sequential and iterative manner.

The process begins with the Input Corpus 201, which represents the initial collection of text data used to train the language model. This corpus contains the raw textual information that serves as the foundation for the model's learning process.

From the Input Corpus, the data flows into the Sparsification Algorithm 202, which represents a crucial transformation stage. This algorithm applies sophisticated techniques to identify and retain only the most significant patterns and relationships within the data, effectively reducing the model's complexity while preserving its essential predictive capabilities.

The output from the sparsification process then enters the Compression stage 203. During this phase, the already sparsified data undergoes further optimization to reduce its storage footprint and computational requirements. The compression process employs advanced techniques to minimize the model's size while maintaining its performance characteristics.

Following compression, the model undergoing Fine-Tuning 204 involves precise adjustments to the model's parameters to optimize its performance for specific tasks or domains. The fine-tuning process helps ensure that the compressed, sparse model maintains high accuracy and reliability in its intended applications.

The process then flows into the Evaluation stage (205), where the model's performance is rigorously assessed against predefined metrics and requirements. This stage measures various aspects of the model's performance, including accuracy, efficiency, and resource utilization.

A notable feature of the process is the feedback loop that connects the Evaluation stage back to the Fine-Tuning stage. This iterative connection allows for continuous optimization of the model based on evaluation results. When evaluation metrics indicate room for improvement, the feedback loop enables additional fine-tuning cycles to enhance the model's performance further.

The feedback loop represents a critical aspect of the system's adaptive capability, enabling performance optimization based on empirical results, iterative refinement of model parameters, continuous improvement of the sparse model's capabilities, and dynamic adjustment to meet specific performance requirements.

This iterative process continues until the model achieves the desired performance metrics, at which point it can be deployed for its intended application. The entire process flow ensures that the resulting sparse language model combines efficient resource utilization with robust performance characteristics.

The systematic approach to creating and optimizing sparse language models, emphasizing both efficiency and effectiveness through careful processing and iterative refinement is central to this invention. This architecture supports the overall goal of maximizing model performance while minimizing computational and storage requirements.

This model employs a carefully designed sparse layer organization that optimizes both computational efficiency and model performance. The architecture implements innovative approaches to input processing and feature extraction, while maintaining a streamlined parameter distribution system. Through this design, the system achieves remarkable efficiency in resource utilization while preserving high-quality output generation. The sparse architecture successfully addresses the fundamental challenge of reducing model complexity while maintaining exceptional performance through its efficient parameter storage and optimized computation paths.

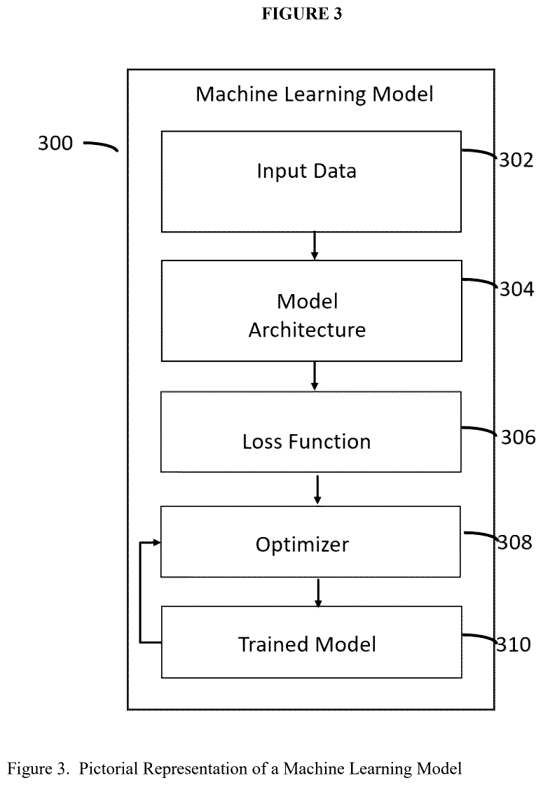

In FIG. 3, the Machine Learning Model 300 represents the comprehensive training process and architectural framework where the systematic flow of input data through various processing stages is used to achieve a fully trained model. This model underpins the sparse language processing system. This integral component encompasses the complete model training workflow, incorporating advanced feature engineering processes and collaborative filtering mechanisms. The machine learning architecture is designed with adaptability at its core, capable of responding to varying input conditions while maintaining optimal performance metrics. The system supports continuous learning capabilities while preserving model efficiency, ensuring sustained improvement over time.

The process begins with Input Data 301, which serves as the foundation for the model's training process. This data represents the collection of training examples and associated features that will be used to train the model. The input data undergoes initial preprocessing and preparation to ensure it is in the appropriate format for model consumption.

The data then flows into the Model Architecture 302 component, which defines the structural framework of the machine learning system. This architecture specifies the model's layers, connections, and computational pathways that will process the input data. Model architecture is designed to support sparse computation and efficient parameter utilization while maintaining the capacity for complex pattern recognition.

From the model architecture, the process moves to the Loss Function 303 stage. The loss function serves as the mathematical framework for measuring the model's performance during training. It quantifies the difference between the model's predictions and the actual target values, providing a crucial metric for optimization. The loss function is carefully designed to account for the sparse nature of the model while ensuring accurate performance measurement.

The process then incorporates the Optimizer 304 component, which represents the mathematical and algorithmic mechanisms for adjusting the model's parameters. The optimizer uses the computed loss values to determine how to modify the model's parameters to improve performance. This component implements sophisticated optimization algorithms that are specifically adapted for sparse model training.

The output of the optimization process feeds into the Trained Model 305 stage, which represents the current state of the model with its updated parameters. The trained model embodies the learned patterns and relationships extracted from the training data, implemented within the sparse architecture.

A key feature of the system is the optimization loop 306 that connects the Optimizer back to the Trained Model. This iterative connection enables continuous refinement of the model's parameters based on performance metrics. The optimization loop represents the dynamic nature of the training process, where the trained model's performance is continuously evaluated, the optimizer calculates necessary parameter adjustments, the updates are applied to the model parameters, and the process repeats until optimal performance is achieved.

This iterative optimization continues until the model reaches a desired level of performance or meets specific convergence criteria. The cyclic nature of the optimization process ensures that the model achieves maximum effectiveness while maintaining its sparse structure and efficient resource utilization.

The entire process flow demonstrated in FIG. 3 represents a carefully designed training pipeline that balances computational efficiency with model performance. The architecture supports the development of sophisticated machine learning models while maintaining the advantages of sparse computation and optimized resource usage.

The training process illustrated in this figure works in conjunction with the sparsification techniques shown in FIG. 2 and integrates with the blockchain verification mechanisms depicted in other figures, creating a comprehensive system for developing and deploying reliable, efficient machine learning models.

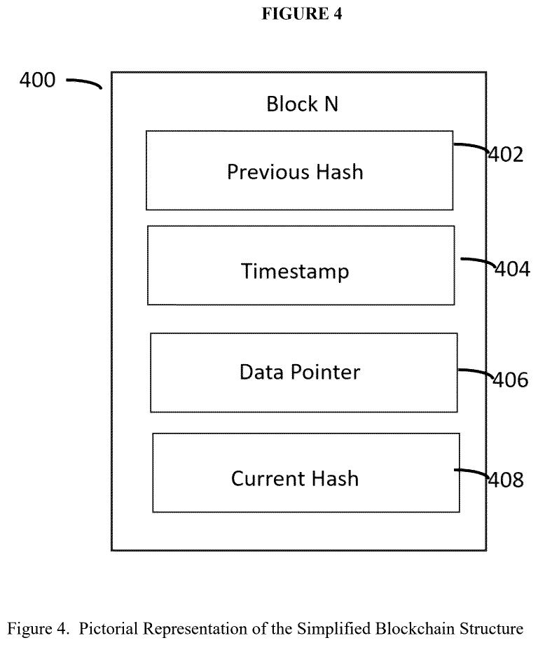

FIG. 4 illustrates the fundamental structure of a single block or Block N 400 within the blockchain system, demonstrating the essential components and their relationships in securing sparse language model results. The diagram depicts the internal architecture of a blockchain block and how its elements are interconnected to maintain data integrity and chronological order.

The block structure begins with the Previous Hash 401, which stores the cryptographic hash value derived from the preceding block (Block N−1). This component serves as a crucial link in the blockchain, ensuring the immutability of the entire chain by creating a cryptographic connection to the historical record of all previous blocks.

The Timestamp 402 follows the previous hash, recording the precise moment when the block was created. This temporal marker ensures chronological ordering of blocks and provides an essential reference point for auditing and verifying the sequence of model operations and their results.

The Data Pointer 403 serves as the reference mechanism to the actual model data and inference results. Rather than storing the complete data within the block itself, this pointer maintains a reference to where the sparse language model results and related information are stored. This approach optimizes storage efficiency while maintaining secure references to all relevant model outputs.

The block structure culminates with the Current Hash 404, which is computed using all previous elements within the block—the previous hash, timestamp, and data pointer. This current hash serves as both a security mechanism and a unique identifier for the block. It ensures that any modification to any component of the block would result in a completely different hash value, making unauthorized alterations immediately detectable.

This block structure creates a robust chain of trust through sequential integrity via previous hash linking, temporal validation through precise timestamps, efficient data management using pointer references, and tamper-evident design through current hash computation

The interconnected nature of these components ensures that each block maintains a verifiable record of sparse language model operations while contributing to the overall security and reliability of the blockchain system. This structure provides an efficient and secure method for tracking and verifying model outputs while maintaining the integrity of the historical record.

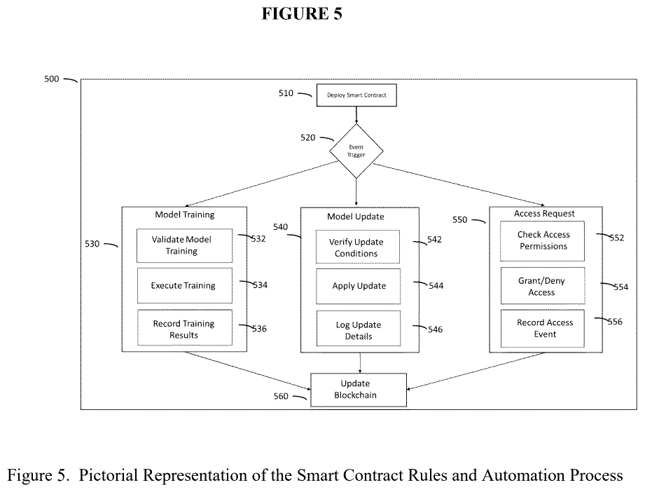

In FIG. 5, the comprehensive smart contract automation system is depicted, which governs the deployment, execution, and management of the sparse language model operations. The diagram depicts the flow of smart contract processes and their interaction with various system components, particularly focusing on event triggering and automated responses.

The process begins with Smart Contract Deployment 510, which represents the initial implementation of the contract rules into the blockchain system. This deployment stage establishes the foundational ruleset that will govern all subsequent automated operations and model interactions.

The Event Trigger 520 component serves as the central coordination mechanism, monitoring and responding to specific system events. When triggered, this component initiates one or more of three primary automated processes:

The Model Training process 530 represents the first automated pathway, which is activated when specific training-related conditions are met. This process initiates new training cycles, validates training parameters, monitors training progress, and records training outcomes. The training process is governed by smart contract rules that ensure all training operations comply with predefined protocols and security requirements.

The Model Update process 540 constitutes the second automated pathway, managing the systematic updating of model parameters and configurations. This process verifies update requirements, implements parameter modifications, validates update results, and maintains update history. The update process ensures that all model modifications are properly authorized and documented within the blockchain.

The Access Request process 550 forms the third automated pathway, handling all requests for model access and utilization. This process validates access credentials, enforces usage permissions, logs access activities, and manages resource allocation. The access control process ensures secure and authorized interaction with the model while maintaining a complete audit trail.

The three processes are interconnected through the smart contract system, which ensures that there is coordinated execution of automated processes, a proper sequencing of operations, maintenance of system integrity, and comprehensive activity logging. The smart contract automation framework provides several key advantages, which are consistent enforcement of system rules, automated response to system events, secure process execution, transparent operation history, and efficient resource management.

This automated system integrates seamlessly with the blockchain structure detailed in FIG. 4 and complements the model architecture shown in FIGS. 2 and 3. The smart contract rules ensure that all system operations, from training to access control, are executed according to predefined protocols while maintaining security and efficiency.

This event-driven architecture enables rapid response to system conditions, automated process initiation, coordinated multi-process execution, and real-time system adaptation. This system achieves reliable process executive with transparency of activities with consistent rule enforcement.

The smart contract and automation process described in FIG. 5 demonstrates the systematic approach to managing sparse language model operations, emphasizing security, efficiency, and reliability through automated control and monitoring.

This invention provides significant advantages in terms of efficiency, security, flexibility, and reliability. The system achieves remarkable computational efficiency through optimized resource utilization and scalable processing capabilities, while maintaining minimal storage requirements. Security is ensured through immutable result verification and distributed trust mechanisms, creating a tamper-evident operational environment. The system's flexibility is demonstrated through multiple deployment options and an adaptable configuration framework, while reliability is maintained through consistent performance and robust error handling mechanisms.

The invention supports various deployment configurations, including cloud-based implementations that leverage distributed processing and elastic scaling capabilities. On-premises installations provide enhanced security and direct control options, while hybrid implementations offer flexible routing and optimized distribution of processing tasks.

Each deployment option maintains the core functionality of the system while adapting to specific operational requirements and constraints. Through this comprehensive integration of sparse language models and blockchain technology, the invention provides a robust and efficient solution for language processing applications that require both high performance and verified results. The system's adaptability and scalability make it suitable for a wide range of applications, from small-scale deployments to enterprise-level implementations.

Alternative embodiments of the invention may incorporate variations in the specific implementation of components while maintaining the core principles of sparse processing and blockchain verification. These variations might include different approaches to parameter optimization, alternative consensus mechanisms, or specialized deployment configurations tailored to specific use cases or operational environments.

1. A method for mitigating overfitting and bias in large language models (LLMs) while ensuring result verification through blockchain integration, comprising:
Utilizing sparse data models to reduce the complexity and size of the LLM,
Recording model states and modifications in an immutable blockchain ledger,
Implementing sparsification techniques including pruning, quantization, and structured sparsity,
Validating model outputs through blockchain-based consensus mechanisms, and
Maintaining verifiable records of model performance and inference results.

2. A system for maintaining model integrity and fair use through blockchain verification, comprising:
A blockchain ledger for recording model states, access events, and modifications,
Smart contracts for automating verification of model results and enforcing usage quotas,
Distributed consensus mechanisms for validating model outputs and updates,
Immutable records of model performance metrics and utilization patterns, and
Authentication and access control mechanisms integrated with blockchain validation.

3. A method for ensuring accountability and verification in sparse language model deployment, comprising:
Recording all model training and update operations in a blockchain ledger,
Implementing automated compliance verification through smart contracts,
Maintaining immutable audit trails of model modifications and access,
Validating inference results through distributed consensus mechanisms, and
Enforcing fair use policies through blockchain-based access controls.
